(19) United States
(12) Patent Application Publication
(10) Pub. No.: US 2022/0223954 A1
(43) Pub. Date: Jul. 14, 2022

(54) MODULAR BATTERY HOUSING FOR MOUNTING BATTERY MODULES TO ONE OF A PLURALITY OF ELECTRIC VEHICLES

(71) Applicant: DUS Operating Inc., Auburn Hills, MI (US)

(72) Inventors: Stephan Roehner, Dortmund (DE); Indraneel Page, Farmington Hills, MI (US); Louie Hanna, Sterling Heights, MI (US); Dana M. Serrels, Davison, MI (US)

(21) Appl. No.: 17/230,077

(22) Filed: Apr. 14, 2021

Related U.S. Application Data
(60) Provisional application No. 63/136,016, filed on Jan. 11, 2021.

(51) Int. Cl. H01M 50/202; H01M 50/102; H01M 50/249; H01M 50/218; H01M 50/24; B60L 50/64

(52) U.S. Cl. CPC H01M 50/202; H01M 50/102; H01M 50/249; H01M 2220/20; H01M 50/24; B60L 50/64; H01M 50/218

(57) ABSTRACT

A modular battery housing is provided for mounting at least one of a plurality of battery modules to an electric vehicle. Each of the battery modules includes a battery module case and one or more battery cells disposed within the battery module case. The modular battery housing includes a frame coupleable to the electric vehicle. The frame includes a pair of rails spaced apart from one another and a plurality of cross members coupleable to the rails. The modular battery housing further includes one or more battery pack enclosures separate from and coupleable to the frame. Each of the battery pack enclosures defines a chamber for sealingly containing at least one of the battery modules, and each of the battery pack enclosures being separate from the battery module case.

### FIELD

The present disclosure relates to electric vehicles, and more particularly, to a universal or modular battery housing for mounting one or more batteries to one of a plurality of vehicles.

### BACKGROUND

Modern electric vehicles can have an aluminum bodies and aluminum extrusion trays that are integral portions of the aluminum body for increasing the stiffness and performance of premium or luxury vehicles. Other modern electric vehicles can have primarily steel bodies and stamped steel trays that are attached to the steel bodies of lower-cost mass produced vehicles. Each of the aluminum extrusion trays and the stamped steel trays are typically configured to mount a specific configuration of battery modules to only corresponding vehicles that require the power provided by the associated battery modules. Each tray typically is not capable of being integrated in other vehicles.

Thus, while battery housings achieve their intended purposes, there is a need for a new and improved modular battery housing assembly that addresses these issues.

### SUMMARY

According to several aspects, a modular battery housing is provided for mounting one or more battery modules to one of a plurality of electric vehicles. Each of the battery modules includes a battery module case and one or more battery cells disposed within the battery module case. The modular battery housing includes a frame coupleable to the electric vehicle. The frame includes a pair of rails spaced apart from one another and a plurality of cross members coupleable to the rails. The modular battery housing further includes one or more battery pack enclosures separate from and coupleable to the frame. Each of the battery pack enclosures defines a chamber for sealingly containing at least one of the battery modules. Each of the battery pack enclosures is separate from the battery module case.

In one aspect, the rails and at least two of the cross members surround and protect a perimeter of an associated one of the battery pack enclosures.

In another aspect, each one of the battery pack enclosures includes a base plate having a peripheral edge. Each battery pack enclosure further includes a plurality of sidewalls extending from the peripheral edge. Each of the sidewalls is separate from the frame and terminates at an end that is distal to the base plate. Each battery pack enclosure further includes a lid removably engaged to the sidewalls for sealingly containing the battery module in the chamber of the battery pack enclosure.

In another aspect, the battery pack enclosure includes the base plate and the sidewalls formed from bending a single panel.

In another aspect, the battery pack enclosure is made of steel, aluminum, or plastic.

In another aspect, the battery pack enclosure further includes a plastic material and a plurality of reinforcement inserts embedded within the plastic material.

In another aspect, the battery pack enclosure is formed by at least one of a panel bending process, a stamping process, a drawing process, a molding process, and a casting process.

In another aspect, each of the cross members and rails is formed by an extrusion process, a casting process, a roll forming process, or a stamping process.

In another aspect, the battery pack enclosure further includes a supplemental base plate that defines one or more coolant passages for flowing coolant through the battery pack enclosure and cooling the battery modules.

In another aspect, the battery pack enclosure further includes a plurality of connectors fluidly connecting the coolant passage to a pump.

According to several aspects, a modular battery housing for an electric vehicle includes a plurality of battery modules corresponding with the associated vehicle. Each of the battery modules includes a battery module case and one or more battery cells disposed within the battery module case. The battery housing further includes a frame coupleable to the electric vehicle. The frame includes a pair of rails spaced apart from one another and a plurality of cross members coupleable to the rails. The rails and the cross members define a plurality of framed sections. The battery housing further includes a plurality of battery pack enclosures separate from and coupleable to the frame. Each of the battery pack enclosures is disposed within an associated one of the framed sections and defines a chamber for sealingly containing an associated one of the battery modules. Each of the battery pack enclosures is separate from the associated battery module cases. Each of the battery pack enclosures includes a base plate having a peripheral edge and a plurality of sidewalls extending from the peripheral edge. Each of the sidewalls terminates at an end that is distal to the base plate. Each of the battery pack enclosures further includes a lid removably engaged to the sidewalls for sealingly containing one or more of the battery modules in the chamber of the associated battery pack enclosure.

In one aspect, the rails and two or more of the cross members surround and protect a perimeter of an associated one of the battery pack enclosures.

In another aspect, each one of the battery pack enclosures includes a base plate having a peripheral edge and a plurality of sidewalls extending from the peripheral edge. Each of the sidewalls is separate from the frame and terminates at an end that is distal to the base plate. Each one of the battery pack enclosures further includes a lid removably engaged to the sidewalls for sealingly containing the battery module in the chamber of the battery pack enclosure.

In another aspect, the battery pack enclosure includes the base plate and the sidewalls that are formed from bending a single panel.

In another aspect, the battery pack enclosure is made of steel, aluminum, or plastic.

According to several aspects, a method of manufacturing a modular battery housing is provided. The method includes determining a plurality of battery modules for supplying power to one of a plurality of electric vehicles. Each of the battery modules includes a battery module case and one or more battery cells disposed within the battery module case. The method further includes forming a pair of rails with each of the rails having a length corresponding with at least one of a subfloor length of the corresponding electric vehicle and an overall length of the battery modules. The method further includes forming a plurality of cross members, with each of the cross members having a length corresponding with at least one of a subfloor width of the corresponding electric vehicle and an overall width of the battery modules. The method further includes attaching the cross members to the rails and forming a plurality of battery pack enclosures that are separate from the frame and the battery modules. The method further includes sealingly containing the battery modules in an associated one of the battery pack enclosures and attaching the battery pack enclosures to the frame.

In one aspect, the method further includes using the rails and at least two of the cross members to define a plurality of framed sections that are separate from the battery pack enclosures. The method further includes disposing the battery modules within an associated one of the framed sections, such that each of the framed sections surround a perimeter of the associated battery pack enclosure.

In another aspect, the method further includes forming each of the battery pack enclosures by forming a base plate with a peripheral edge that corresponds with a battery module width and a battery module length of the associated battery module disposed in the battery pack enclosure. The method further includes forming each of the battery pack enclosures by forming a plurality of sidewalls that extend from the peripheral edge and correspond with a battery module height of the associated battery module. Each of the sidewalls terminates at an end distal to the base plate. The method further includes removably engaging a lid to the distal end of the sidewalls for sealingly containing the associated battery module.

In another aspect, the method further includes forming each of the battery pack enclosures by bending, stamping, drawing, molding, or casting a work piece into the battery pack enclosure.

In another aspect, the frame is formed by extruding the rails to have the length corresponding with at least one of the subfloor length of the corresponding electric vehicle and the overall length of the battery modules. The method further includes extruding the cross members to have the length corresponding with at least one of the subfloor width of the corresponding electric vehicle and the overall width of the battery modules. The cross members are then attached to the rails.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

FIG. 1 is an upper perspective view of one example of a modular battery housing for an electric vehicle.

FIG. 2 is a lower perspective view of the modular battery housing of FIG. 1.

FIG. 3 is a cross-sectional view of the modular battery housing of FIG. 1, as taken along line 3-3, illustrating the modular battery housing having a frame for supporting multiple battery pack enclosures that sealingly contain an associated one of battery pack modules.

FIG. 4 is a perspective view of the frame of FIG. 3.

FIG. 5 is an exploded view of the battery pack enclosures of FIG. 3.

FIG. 6 is a cross-sectional view of the modular battery housing of FIG. 1, as taken along line 6-6, illustrating a plurality of fasteners for attaching a lid and a back plate to the frame.

FIG. 7 is an enlarged perspective cross-sectional view of the modular battery housing of FIG. 1.

FIG. 8 is an enlarged partially cutaway view of the modular battery housing of FIG. 1, illustrating the modular battery housing having a supplemental cooling plate with coolant passages and connectors for fluidly connecting the coolant passages to a pump.

FIG. 9 is a flow chart of one example of a method for manufacturing the modular battery housing of FIG. 1.

### DETAILED DESCRIPTION

The following description is merely exemplary in nature and is not intended to limit the present disclosure, application, or uses. Although the drawings represent examples, the drawings are not necessarily to scale and certain features may be exaggerated to better illustrate and explain a particular aspect of an illustrative example. Any one or more of these aspects can be used alone or in combination within one another. Further, the exemplary illustrations described herein are not intended to be exhaustive or otherwise limiting or restricting to the precise form and configuration shown in the drawings and disclosed in the following detailed description. Exemplary illustrations are described in detail by referring to the drawings as follows:

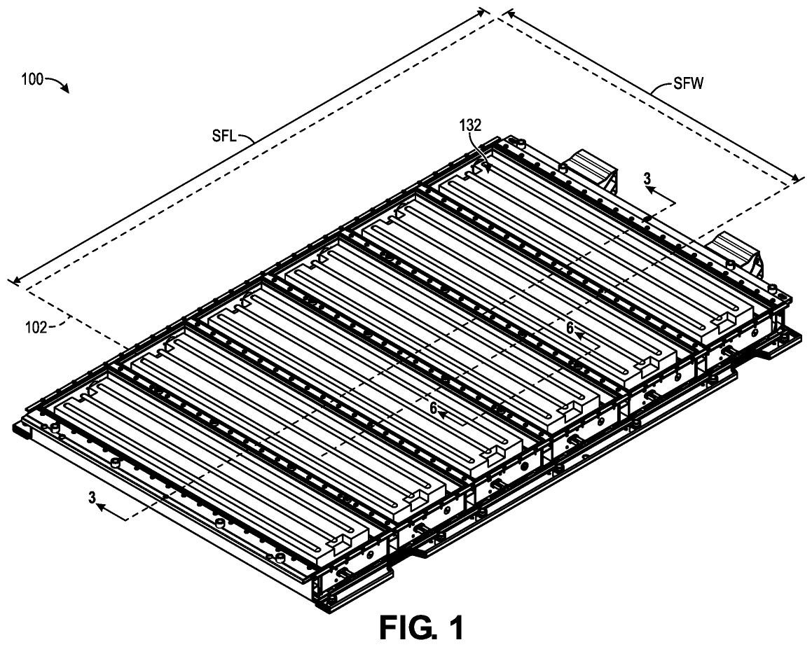

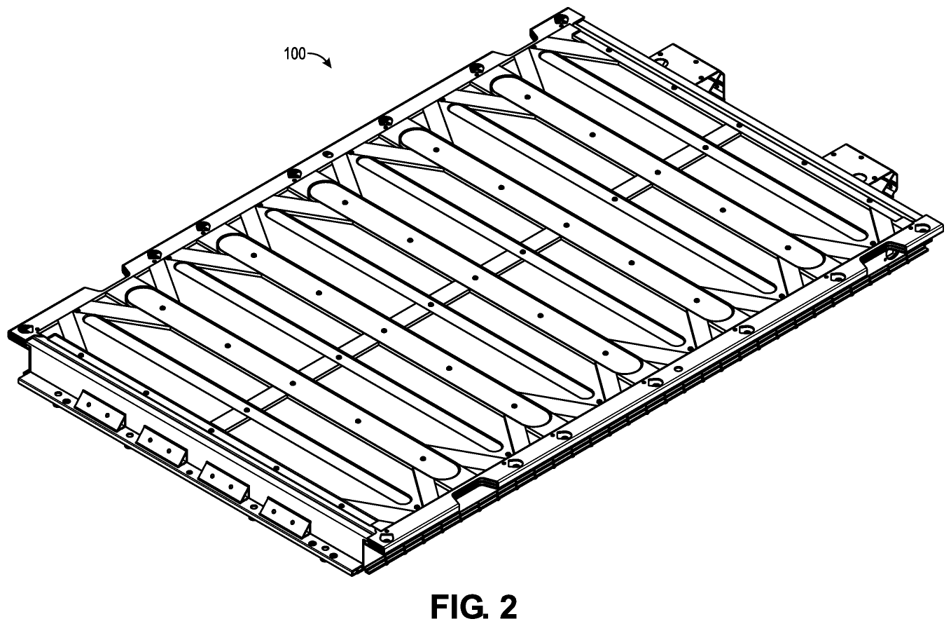

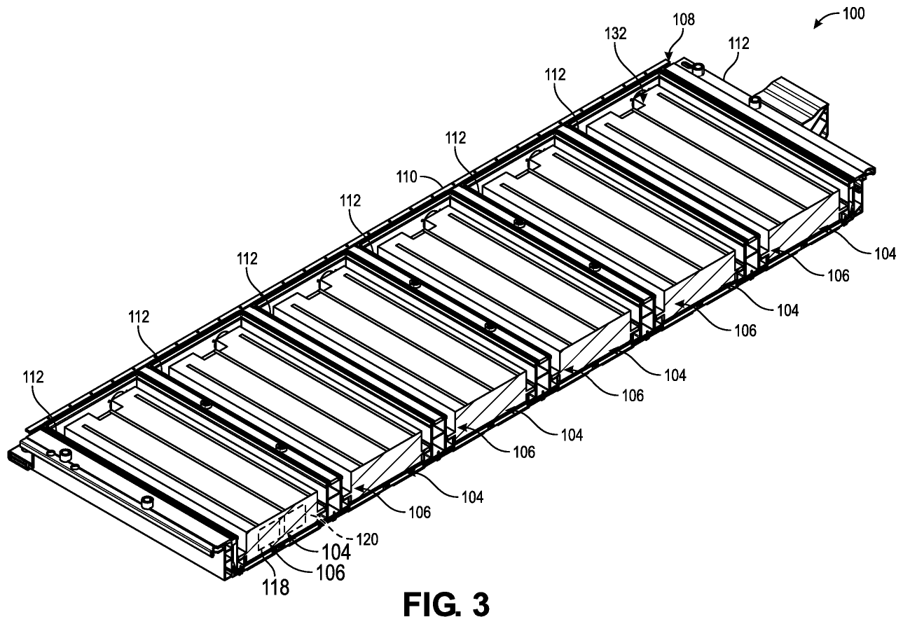

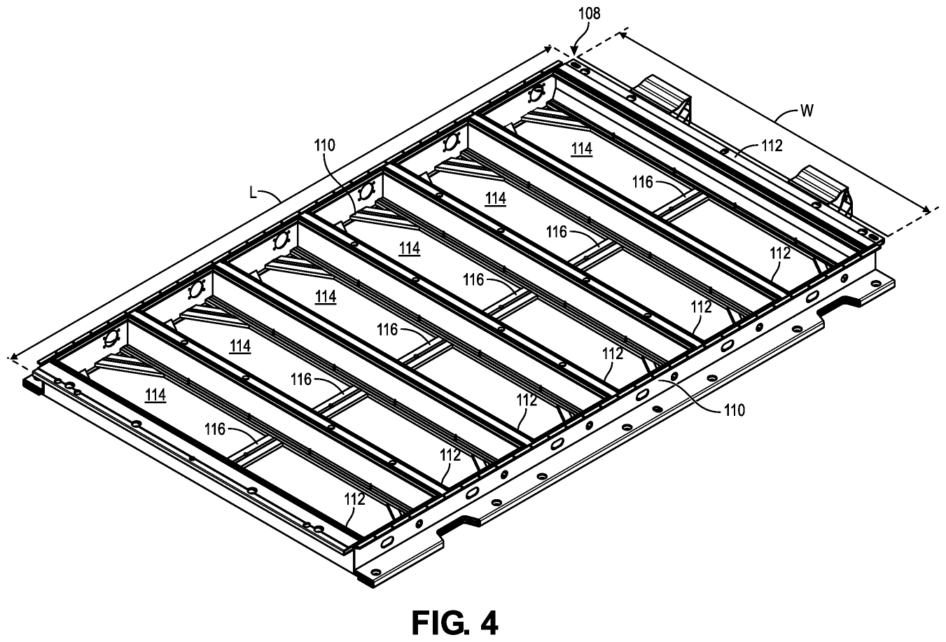

Referring to FIGS. 1 and 2, there is generally shown one example of a modular battery tray or housing 100 (“modular battery housing”) for attachment to a subfloor 102 of any one of a plurality of electric vehicles. As described in detail below, the modular battery housing 100 includes one or more battery pack enclosures 104 (FIG. 3) for sealingly containing one or more battery modules 106, such that each battery pack enclosure 102 can isolate a local leak and prevent the leak from propagating to other portions of the modular battery housing or the external environment. In addition, the modular battery housing 100 includes a modular frame 108 (FIGS. 3 and 4) that surrounds and protects the battery pack enclosures 104. The modular frame 108 is adapted to mount any number and configuration of battery pack enclosures 104 to the subfloor or other suitable portion of a vehicle.

Referring to FIG. 4, the frame 108 includes a pair of rails 110 spaced apart from one another and a plurality of cross members 112 coupleable to the rails 110 to define a plurality of framed sections 114, with the framed sections 114 receiving and protecting a perimeter of associated battery pack enclosures 104 (FIG. 3). Also in this example, the frame 108 further includes a plurality of cross braces 116 coupleable to the cross members 112. The frame 108 provides crash intrusion protection and facilitates mounting of the battery pack enclosures within the vehicle. The frame 108 also facilitates removal and re-installation of the battery systems for serviceability. While this non-limiting example of the frame includes two rails 110, seven cross members 112, and six cross braces 116, it is contemplated that the frame can have any number of rails, cross members, and cross braces for protecting and mounting any number of battery pack enclosures to the corresponding with the electric vehicle. In this example, each of the cross members 112 and each of the rails 110 can be formed with a nominal length by an extrusion process. In a subsequent process, each of rails 110 can be cut to a length corresponding with a subfloor length SFL (FIG. 1) of the electric vehicle and/or the battery modules, and each of the cross members 112 can be cut to a length corresponding with a subfloor width SFW (FIG. 1) of the electric vehicle and/or the battery modules. In other examples, the rails and the cross members can be formed from a casting process, a roll forming process, a stamping process, or other suitable manufacturing processes.

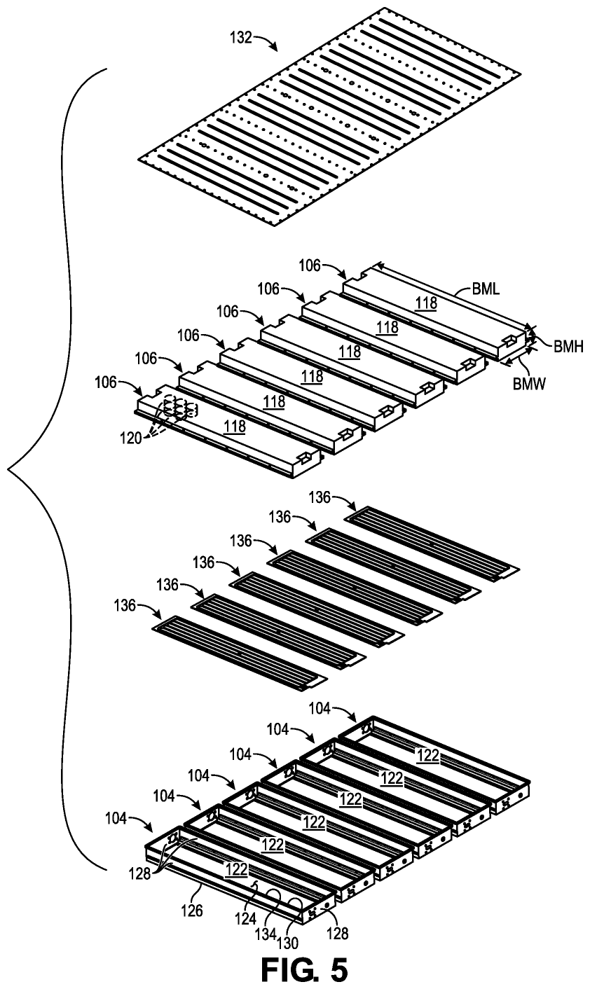

Referring now to FIG. 5, one or more battery pack enclosures 104 (FIG. 3) sealingly contain one or more battery modules 106 for providing environmental protection for the battery modules 106 from dust, water spray, and other potentially damaging road conditions, containing any leaks from the battery modules 106, and providing electrical safety protection of the battery modules 106. Each battery module 106 includes a battery module case 118 and one or more battery cells 120 disposed within the battery module case 118. In this non-limiting example, the modular battery housing 100 includes six battery pack enclosures 104 containing an associated one of six battery modules 106. Each battery pack enclosure 104 extends across the entire width of the frame 108. In other examples, the modular battery housing can have more or fewer than six battery pack enclosures and extend across only a portion of the frame.

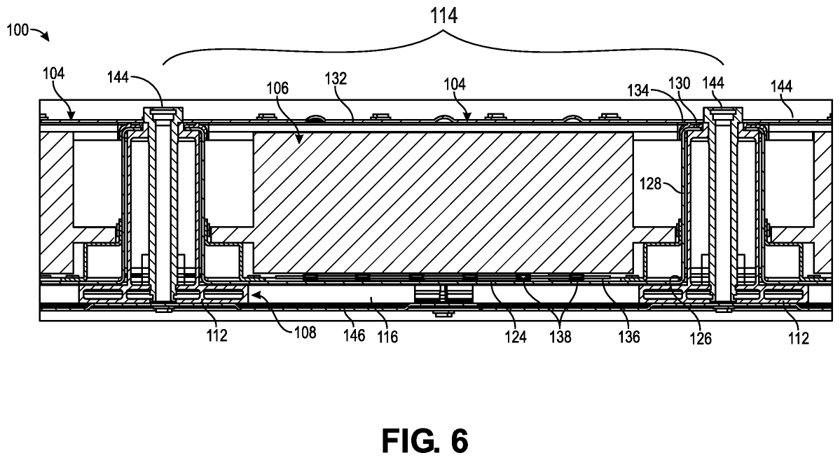

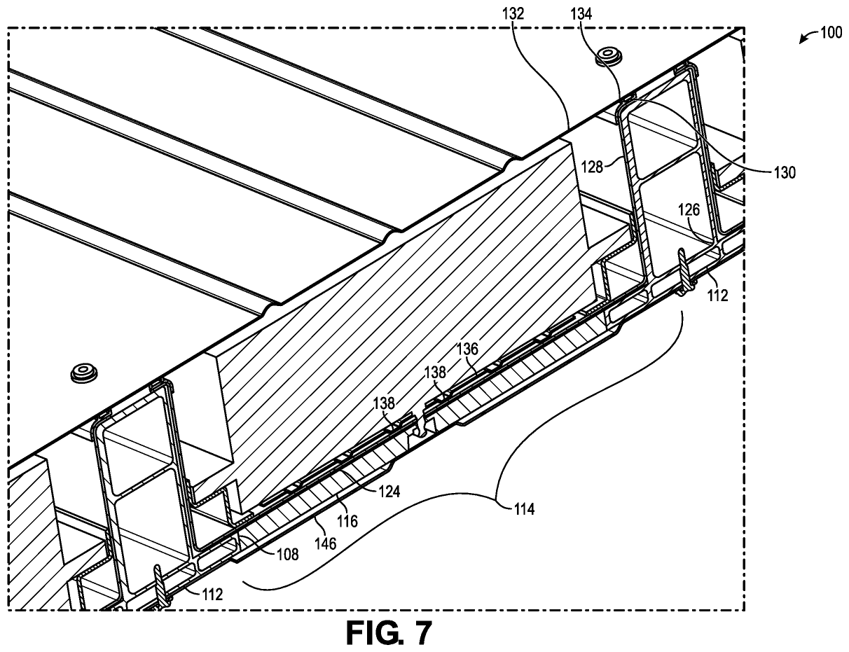

As shown in FIGS. 6 and 7, the battery pack enclosure 104 is separate from and coupleable to the frame 108, and each of the battery pack enclosures 104 is received within and protected by an associated one of the framed sections 114 (FIGS. 3 and 4). Each battery pack enclosure 104 defines a chamber 122 for sealingly containing the associated battery module 106, and each battery pack enclosure 104 includes a base plate 124 having a peripheral edge 126. Each battery pack enclosure 104 further includes a plurality of sidewalls 128 extending from the peripheral edge 126, with each of the sidewalls 128 terminating at an end 130 distal to the base plate 124. In this example, the base plate 124 and the plurality of sidewalls 128 are formed from a single metal panel formed or stamped into a box shape. The base plate 124 and the sidewalls 128 form a receptacle for containing one of the battery modules 106. However, it is contemplated that any of the battery pack enclosures can include a plurality of the battery modules. In another example, the base plate 124 and the sidewalls 128 are a plastic injection molded body with reinforcement inserts embedded within the body. In still another example, the base plate and the sidewalls are separate components attached to one another and made of steel, aluminum, molded glass reinforced plastic, or any other suitable material. The battery pack enclosure 104 is formed by at least one of panel bending, stamping, drawing, molding, casting, or other suitable manufacturing processes. The battery pack enclosure can be fabricated utilizing various manufacturing techniques, such as, panel bending, stamping/drawing, molding or casting.

As best shown in FIGS. 5-7, each battery pack enclosure 104 further includes a common lid 132 removably engaged to a seal 134 on the sidewalls 128 of each of the battery pack enclosures 104 for sealingly containing one or more of the battery modules 106 in the chamber 122 of the battery pack enclosure 104. In this example, the lid 132 is a common lid for all of the battery pack enclosures 104 and configured to engage one or more seals 134 associated with each of the battery pack enclosures 104. While the common lid can allow the battery module housing to be assembled efficiently, other examples of the battery module housing can have a plurality of separate lids for an associated one of the chambers.

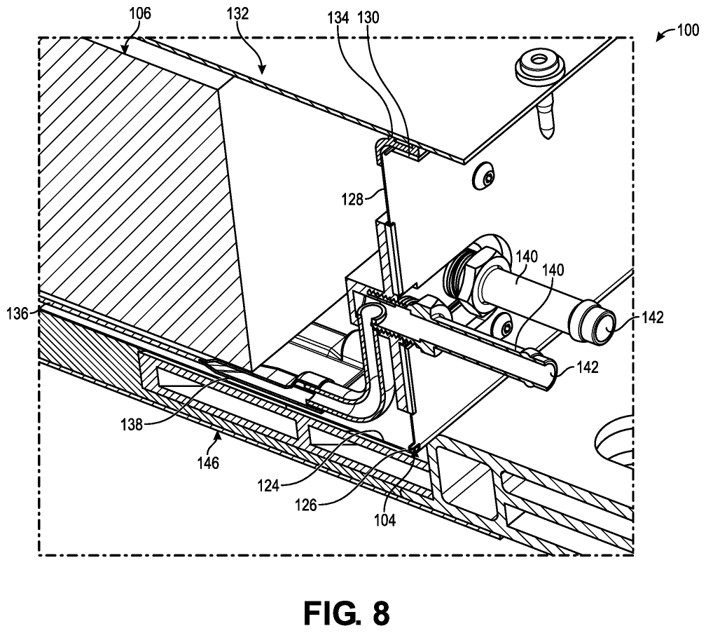

As shown in FIG. 8, each battery pack enclosure 104 further includes a supplemental plate 136 defining one or more coolant passages 138 for flowing coolant through the supplemental plate 136 and cooling the battery modules 106. However, it is contemplated that at least one of the base plate 124, the sidewalls 128, the lid 132, and any other portion of the battery pack enclosure can define coolant passages. As shown in FIG. 2, the modular battery housing 100 includes a plurality of connectors 140 mounted to each battery pack enclosure 104 and fluidly connecting the coolant passages 138 of each battery pack enclosure 104 to a pump 142 for flowing the coolant through the coolant passages 138.

As compared to known battery housings, the modular battery housing reduces the complexity of design, manufacturing, and assembly by segregating the functions of the battery housing into the battery pack enclosure 104 for sealingly containing the battery modules and the frame 108 for supporting the battery pack enclosures and mounting them to the subfloor. Separating the functions of the battery housing facilitates optimizing each sub-structure for their intended performance, reducing manufacturing complexity, improving sealing capability and allows the possibility of introducing mixed materials for reduced weight and cost.

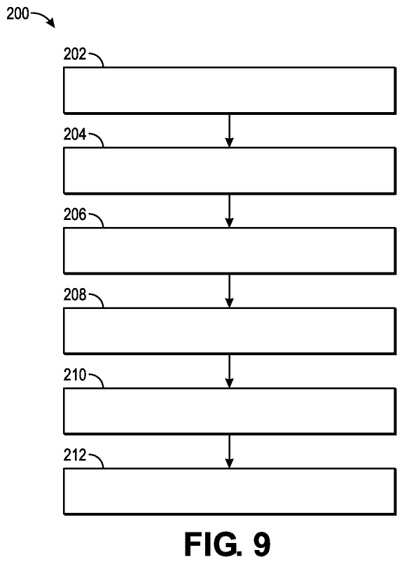

Referring to FIG. 9, a flow chart of one example of a method 200 of manufacturing the modular battery housing of FIG. 1 is illustrated. The method 200 begins at block 202 with the step of determining the plurality of battery modules 106 for supplying power to one of a plurality of electric vehicles. It will be appreciated that different model years, trims, and makes can require power from unique configuration of battery modules.

At block 204, the frame 108 is formed. This step can be accomplished by forming the rails 110 with each of the rails 110 having a length corresponding with the subfloor length SFL of the corresponding electric vehicle and/or the overall length of the battery modules 106. This step can be further accomplished by the cross members 112 being formed with a length corresponding with the subfloor width SFW of the corresponding electric vehicle and/or the overall width of the battery modules 106.

In this example, the rails 110 and the cross members 112 are extruded to have associated nominal lengths. The rails 110 can then be cut to length corresponding with subfloor length SFL of the corresponding electric vehicle and/or the overall length of the battery modules 106, and the cross members 112 can be cut to a length corresponding with the subfloor width SFW of the corresponding electric vehicle and/or the overall width of the battery modules. The cross members 112 are then welded to the rails 110. However, it is contemplated that the rails and the cross members can be formed and connected to one another by other suitable manufacturing processes.

At block 206, the battery pack enclosures associated with the battery modules 106 for the electric vehicle are formed. This step can be accomplished by forming the base plate 124 with the peripheral edge 126 and sidewalls 128 extending from the peripheral edge 126. The sidewalls 128 and the base plate 124 can be formed by at least one of bending, stamping, drawing, molding, and casting a work piece into the battery pack enclosure 104 for the electric vehicle. The peripheral edge 126 corresponds with the battery module width BMW and the battery module length BML of the associated battery module 106 contained within the battery pack enclosure 104. Each of the sidewalls 128 terminates at the end 130 distal to the base plate 124, and the height of the sidewalls 128 corresponds with the battery module height BMH of the associated battery module 106. The lid 132 is engaged to the sidewalls 128 for sealingly containing the battery modules 106 in the battery pack enclosure 104. The cross members 112 are attached to the rails 110, such that the rails and at least two of the cross members define the framed sections, and cross braces 116 are attached to the cross members 112 to reinforce the frame 108. The rails 110, the cross members 112 and the cross braces 116 are separate from the battery pack enclosures 104.

In this non-limiting example, six battery pack enclosures 104 are formed, with each battery pack enclosure extending across the width of the frame 108. In other examples, the modular battery housing can include more or fewer than six battery pack enclosures with other suitable shapes and arrangements relative to the frame depending on the battery modules required to supply power to the electric vehicle. Supplemental plates 136 with coolant passages 138 can be disposed within the chamber 122 for supporting and cooling the battery module 106 within the battery pack enclosure 104.

At block 210, the battery pack enclosures 104 are disposed within an associated one of the framed sections 114 such that each of the framed sections 114 surrounds and protects a perimeter of each battery pack enclosure 104. The connectors 140 fluidly connect the coolant passages 138 of the supplemental plates 136 to the pump 142.

At block 212, the battery pack enclosures 104 are attached to the frame 108. In this example, the common lid 132 is engaged to the seals 134 supported by the distal end 130 of the associated sidewalls 128. Bolt fasteners 144 can attach the lid 132 to the cross members 112, such that the battery pack enclosures 104 are attached to the frame 108 and the battery modules 106 are sealingly contained in the associated battery pack enclosures 104. The bolt fasteners 144 can further attach a back plate 146 to the frame 108 to surround the battery pack enclosures 104 and protect the battery pack enclosures 104 from dust, water spray, and other potentially damaging road conditions. However, it is contemplated that two or more battery modules can be disposed in any one of the battery pack enclosures.

The description of the present disclosure is merely exemplary in nature and variations that do not depart from the general sense of the present disclosure are intended to be within the scope of the present disclosure. Such variations are not to be regarded as a departure from the spirit and scope of the present disclosure.

What is claimed is:

1. A modular battery housing for mounting at least one of a plurality of battery modules to an electric vehicle, with each of the battery modules including a battery module case and at least one battery cell disposed within the battery module case, the modular battery housing comprising:
a frame coupleable to the electric vehicle, with the frame including:
a pair of rails spaced apart from one another; and
a plurality of cross members coupleable to the rails; and
at least one battery pack enclosure separate from and coupleable to the frame, with each of the battery pack enclosures defining a chamber for sealingly containing at least one of the battery modules, and each of the battery pack enclosures being separate from the battery module case.

2. The modular battery housing of claim 1 wherein the rails and at least two of the cross members surround and protect a perimeter of an associated one of the battery pack enclosures.

3. The modular battery housing of claim 2 wherein each one of the battery pack enclosures comprises:
a base plate having a peripheral edge;
a plurality of sidewalls extending from the peripheral edge, with each of the sidewalls separate from the frame and terminating at an end that is distal to the base plate; and
a lid removably engaged to the sidewalls for sealingly containing the at least one battery module in the chamber of the battery pack enclosure.

4. The modular battery housing of claim 3 wherein the battery pack enclosure comprises the base plate and the plurality of sidewalls that are formed from bending a single panel.

5. The modular battery housing of claim 3 wherein the battery pack enclosure comprises at least one of steel, aluminum, and plastic.

6. The modular battery housing of claim 3 wherein the battery pack enclosure further comprises a plastic material and a plurality of reinforcement inserts embedded within the plastic material.

7. The modular battery housing of claim 3 wherein the battery pack enclosure is formed by at least one of a panel bending process, a stamping process, a drawing process, a molding process, and a casting process.

8. The modular battery housing of claim 3 wherein each of the cross members and each of the rails is formed by at least one of an extrusion process, a casting process, a roll forming process, and a stamping process.

9. The modular battery housing of claim 3 wherein a supplemental base plate defines at least one coolant passage for flowing coolant through the battery pack enclosure and cooling the at least one battery module.

10. The modular battery housing of claim 9 wherein the battery pack enclosure further comprises a plurality of connectors fluidly connecting the at least one coolant passage to a pump.

11. A modular battery housing for an electric vehicle, comprising:
a plurality of battery modules, with each of the battery modules including a battery module case and at least one battery cell disposed within the battery module case;
a frame coupleable to the electric vehicle, with the frame including:
a pair of rails spaced apart from one another; and
a plurality of cross members coupleable to the rails, with the rails and the cross members defining a plurality of framed sections;
a plurality of battery pack enclosures separate from and coupleable to the frame, with each of the battery pack enclosures disposed within an associated one of the framed sections and defining a chamber for sealingly containing at least one of the battery modules, each of the battery pack enclosures being separate from the associated battery module case, and each of the battery pack enclosures comprises:
a base plate having a peripheral edge;
a plurality of sidewalls extending from the peripheral edge, with each of the sidewalls terminating at an end that is distal to the base plate; and
a lid removably engaged to the sidewalls for sealingly containing at least one of the battery modules in the chamber of the associated battery pack enclosure.

12. The modular battery housing of claim 11 wherein the rails and at least two of the cross members surround and protect a perimeter of an associated one of the battery pack enclosures.

13. The modular battery housing of claim 12 wherein each one of the battery pack enclosures comprises:
a base plate having a peripheral edge;
a plurality of sidewalls extending from the peripheral edge, with each of the sidewalls separate from the frame and terminating at an end distal to the base plate; and
a lid removably engaged to the sidewalls for sealingly containing the at least one battery module in the chamber of the battery pack enclosure.

14. The modular battery housing of claim 13 wherein the battery pack enclosure comprises the base plate and the plurality of sidewalls that are formed from bending a single panel.

15. The modular battery housing of claim 13 wherein the battery pack enclosure comprises at least one of steel, aluminum, and plastic.

16. A method of manufacturing a modular battery housing, the method comprising:
determining a plurality of battery modules for supplying power to one of a plurality of electric vehicles, with each of the battery modules including a battery module case and at least one battery cell disposed within the battery module case;
forming a pair of rails with each of the rails having a length corresponding with at least one of a subfloor length of the corresponding electric vehicle and the plurality of battery modules;
forming a plurality of cross members with each of the cross members having a length corresponding with at least one of a subfloor width of the corresponding electric vehicle and the plurality of battery modules;
forming a frame by attaching the cross members to the rails;
forming a plurality of battery pack enclosures that are separate from the frame and the battery modules;
sealingly containing the battery modules in an associated one of the battery pack enclosures; and
attaching the battery pack enclosures to the frame.

17. The method of claim 16 further comprising:
forming, using the rails and at least two of the cross members, a plurality of framed sections that are separate from the battery pack enclosures; and
disposing the plurality of battery pack enclosures within an associated one of the framed sections such that each of the framed sections surrounds a perimeter of the associated battery pack enclosure.

18. The method of claim 17 wherein forming each of the battery pack enclosures comprises:
forming a base plate having a peripheral edge corresponding with a battery module width and a battery module length of the associated battery module disposed in the battery pack enclosure;
forming a plurality of sidewalls extending from the peripheral edge and corresponding with a battery module height of the associated battery module, with each of the sidewalls terminating at an end distal to the base plate; and
removably engaging a lid to the distal end of the sidewalls for sealingly containing the associated battery module.

19. The method of claim 18 wherein forming each of the battery pack enclosures comprises at least one of bending, stamping, drawing, molding, and casting a work piece into the battery pack enclosure.

20. The method of claim 19 wherein forming the frame comprises:
extruding the rails to have the length corresponding with at least one of the subfloor length of the corresponding electric vehicle and the plurality of battery modules;
extruding the cross members to have the length corresponding with at least one of the subfloor width of the corresponding electric vehicle and the plurality of battery modules; and
attaching the cross members to the rails.
